(19) United States
(12) Patent Application Publication
(10) Pub. No.: US 2026/0164439 A1
(43) Pub. Date: Jun. 11, 2026

(54) PUCCH RESOURCES FOR REDUCED BANDWIDTH WIRELESS DEVICES

(71) Applicant: Telefonaktiebolaget LM Ericsson (PUBL), Stockholm (SE)

(72) Inventors: Mohammad Mozaffari, FREMONT, CA (US); Sandeep Narayanan Kadan Veedu, JÄRFÄLLA (SE); Johan Bergman, STOCKHOLM (SE)

(21) Appl. No.: 18/706,532

(22) PCT Filed: Nov. 7, 2022
(86) PCT No.: PCT/IB2022/060694

§ 371 Date: May 1, 2024

Related U.S. Application Data
(60) Provisional application No. 63/276,501, filed on Nov. 5, 2021.

(51) Int. Cl. H04W 72/21; H04L 5/00

(52) U.S. Cl. CPC H04W 72/21; H04L 5/0012

(57) ABSTRACT

According to some embodiments, a method performed by a wireless device comprises determining a physical uplink control channel (PUCCH) resource set to be used by a reduced capability (RedCap) wireless device for initial uplink and transmitting one or more PUCCH transmissions using the determined PUCCH resource set. Determining the PUCCH resource set may comprise determining that frequency hopping is disabled.

### TECHNICAL FIELD

Embodiments of the present disclosure are directed to wireless communications and, more particularly, to physical uplink control channel (PUCCH) resources for reduced bandwidth wireless devices.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

The next paradigm shift in processing and manufacturing is referred to as Industry 4.0, in which factories are automated and made more flexible and dynamic with the help of wireless connectivity. This includes real-time control of robots and machines using time-critical machine-type communication (cMTC) and improved observability, control, and error detection with the help of large numbers of more simple actuators and sensors (massive machine-type communication or mMTC). For cMTC support, ultra-reliable low latency communications (URLLC) was introduced in the Third Generation Partnership Project (3GPP) Release 15 for both Long Term Evolution (LTE) and New Radio (NR), and NR URLLC is further enhanced in Release 16 within the enhanced URLLC (eURLLC) and Industrial Internet-of-Things (IIoT) work items.

For mMTC and low power wide area (LPWA) support, 3GPP introduced both narrowband Internet-of-Things (NB-IoT) and long-term evolution for machine-type communication (LTE-MTC, or LTE-M) in Release 13. These technologies have been further enhanced through all releases up until and including the ongoing Release 16 work.

NR was introduced in 3GPP Release 15 and focused mainly on enhanced mobile broadband (eMBB) and cMTC. However, there are still several other use cases whose requirements are higher than those of LPWA networks (i.e., LTE-M/NB-IoT) but lower than those of URLLC and eMBB. In order to efficiently support such use cases that are in-between eMBB, URLLC, and mMTC, 3GPP has studied reduced capability NR devices (RedCap) in Release 17 (Rel-17). The RedCap study item was completed in March 2021. A corresponding RedCap work item was started in December 2020 and is expected to be finalized in September 2022.

The RedCap user equipments (UEs) are required to have lower cost, lower complexity, a longer battery life, and potentially a smaller form factor than legacy NR UEs. Therefore, several different complexity reduction features will be specified for RedCap UEs in Rel-17. These complexity reduction features are listed in the Rel-17 work item description (WID) for RedCap. The WID is RP-211574, “Revised WID on support of reduced capability NR devices”, Ericsson, 3GPP TSG RAN #92e, June 2021. The WID specifies support for reduced maximum UE bandwidth. The maximum bandwidth of a frequency range 1 (FR1) RedCap UE during and after initial access is 20 MHz. The maximum bandwidth of a frequency range 2 (FR2) RedCap UE during and after initial access is 100 MHz.

For support of UEs with different capabilities (e.g., bandwidth) in a network, it is important to ensure an efficient coexistence of different UEs while considering resource utilization, network spectral/energy efficiency, and scheduling complexity. In this regard, it is beneficial to have the shared initial downlink and uplink bandwidth parts (BWPs) between different UEs particularly to avoid resource fragmentation and improve resource efficiency. For example, it is desired to support shared initial BWPs (which are used for initial access) between RedCap UEs and legacy UEs.

The first step in initial access is that a UE detects the downlink synchronization reference signals, including primary synchronization signal (PSS) and secondary synchronization signal (SSS). Following that, the UE reads the physical broadcast channel (PBCH), which includes master information block (MIB). Among other information, MIB contains PDCCH-ConfigSIB1, which is the configuration of core resource set (CORESET) #0. After decoding CORESET0, which is the downlink assignment for the remaining system information, the UE can receive the system information base 1 (SIB1), which includes the random access channel (RACH) configuration.

Random access is the procedure of a UE accessing a cell, receiving a unique identification by the cell, and receiving the basic radio resource configurations. The steps of four-step random access are as follows:
UE transmits a preamble referred to as physical random access channel (PRACH)
Network sends random access response (RAR), indicating reception of preamble and providing time-alignment command
UE sends a physical uplink shared channel (PUSCH), also referred to as Message 3, for resolving collision
Network sends the contention resolution message, also referred to as Message 4
UE sends the ACK/NACK for Msg4 on the physical uplink control channel (PUCCH).

In general, PUCCH is used by the device for carrying uplink control information (UCI) for various purposes such as hybrid automatic repeat request (HARQ) feedback, CSI (Channel State Information) and SR (Scheduling Request). NR supports five different PUCCH formats (i.e., Formats 0-4). PUCCH formats 0 and 2, which are known as short formats, occupy 1 or 2 orthogonal frequency division multiplexing (OFDM) symbols. PUCCH formats 1, 3 and 4 are known as long formats, which occupy 4 to 14 OFDM symbols. Moreover, frequency hopping is supported for long PUCCH formats and for short PUCCH formats of duration two symbols.

Before a dedicated radio resource control (RRC) connection (i.e., during random/initial access), the PUCCH configuration is done in PUCCH-ConfigCommon (shown in Table 1 and reproduced from TS 38.331, v. 15.8.0 “NR; Radio Resource Control (RRC) protocol specification”) from SIB1. The information element (IE) PUCCH-ConfigCommon is used to configure the cell specific PUCCH parameters.

TABLE 1
PUCCH-ConfigCommon information element.

| PUCCH-ConfigCommon ::= | SEQUENCE { |
|---|---|
| pucch-ResourceCommon | INTEGER (0..15) |
| OPTIONAL, -- Cond InitialBWP-Only | |
| pucch-GroupHopping | ENUMERATED { neither, |
| | enable, disable }, |
| hoppingId | INTEGER (0..1023) |
| OPTIONAL, -- Need R | |
| p0-nominal | INTEGER (−202..24) |

OPTIONAL, -- Need R
...
}

The pucch-ResourceCommon is an entry into a 16-row table where each row configures a set of cell-specific PUCCH resources/parameters. The UE uses those PUCCH resources until it is provided with a dedicated PUCCH-Config (e.g., during initial access) on the initial uplink BWP.

Such PUCCH configuration in PUCCH-ConfigCommon only supports short Format 0 with two symbols and long Format 1 with 4, 10, and 14 symbols. Also, in this configuration frequency hopping is always applied. Therefore, for PUCCH transmissions for Msg4 (four-step RACH) or MsgB (two-step RACH) HARQ feedback during the random access procedure, the frequency hopping within a slot (intra-slot frequency hopping) is always enabled. An example is illustrated in FIG. 1.

FIG. 1 is a time and frequency diagram illustrating an example of PUCCH configuration with intra-slot frequency hopping enabled. The horizontal axis represents time and the vertical axis represents frequency.

The related part of NR specifications for determining the PUCCH resource sets that can be used for PUCCH transmissions is reproduced below from TS 38.213, “NR; Physical layer procedures for control”, V16.1.0, March 2020.

### 9.2.1 PUCCH Resource Sets

If a UE does not have dedicated PUCCH resource configuration, provided by PUCCH-ResourceSet in PUCCH-Config, a PUCCH resource set is provided by pucch-ResourceCommon through an index to a row of Table 9.2.1-1 for transmission of HARQ-ACK information on PUCCH in an initial UL BWP of

$${N}_{BWP}^{size} PRBs .$$

The PUCCH resource set includes sixteen resources, each corresponding to a PUCCH format, a first symbol, a duration, a PRB offset

$${RB}_{BWP}^{offset} ,$$

and a cyclic shift index set for a PUCCH transmission. The UE transmits a PUCCH using frequency hopping. An orthogonal cover code with index 0 is used for a PUCCH resource with PUCCH format 1 in Table 9.2.1-1. The UE transmits the PUCCH using the same spatial domain transmission filter as for a PUSCH transmission scheduled by a RAR UL grant as described in Subclause 8.3.

If a UE is not provided pdsch-HARQ-ACK-Codebook, the UE generates at most one HARQ-ACK information bit.

If the UE provides HARQ-ACK information in a PUCCH transmission in response to detecting a DCI format 1_0 or DCI format 1_1, the UE determines a PUCCH resource with index r_{PUCCH}, 0≤r_{PUCCH}≤15, as

$${r}_{PUCCH} = ⌊ \frac{2 \cdot {n}_{CCE , 0}}{{N}_{CCE}} ⌋ + 2 \cdot {Δ}_{PRI} ,$$

where N_{CCE} is a number of CCEs in a CORESET of a PDCCH reception with DCI format 1_0 or DCI format 1_1, as described in Subclause 10.1, n_{CCE,0} is the index of a first CCE for the PDCCH reception, and Δ_{PRI} is a value of the PUCCH resource indicator field in the DCI format 1_0 or DCI format 1_1.

If └r_{PUCCH}/8┘=0
the UE determines the PRB index of the PUCCH transmission in the first hop as

$${RB}_{BWP}^{offset} + ⌊ {r}_{PUCCH} / {N}_{CS} ⌋$$

and the PRB index of the PUCCH transmission in the second hop as

$${N}_{BWP}^{size} - 1 - {RB}_{BWP}^{offset} - ⌊ {r}_{PUCCH} / {N}_{CS} ⌋ ,$$

where N_{CS} is the total number of initial cyclic shift indexes in the set of initial cyclic shift indexes
the UE determines the initial cyclic shift index in the set of initial cyclic shift indexes as r_{PUCCH} mod N_{CS}

If └r_{PUCCH}/8┘=1
the UE determines the PRB index of the PUCCH transmission in the first hop as

$${N}_{BWP}^{size} - 1 - {RB}_{BWP}^{offset} - ⌊ ( {r}_{PUCCH} - 8 ) / {N}_{CS} ⌋ ,$$

and the PRB index of the PUCCH transmission in the second hop as

$${RB}_{BWP}^{offset} + ⌊ ( {r}_{PUCCH} - 8 ) / {N}_{CS} ⌋$$

the UE determines the initial cyclic shift index in the set of initial cyclic shift indexes as (r_{PUCCH}−8)mod N_{CS}

TABLE 92.1-1
PUCCH resource sets before dedicated PUCCH resource configuration

| | PUCCH | First | Number of | PRB offset | Set of initial |
|---|---|---|---|---|---|
| Index | format | symbol | symbols | RB_{BWP}^{offset} | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | $⌊ {N}_{BWP}^{size} / 4 ⌋$ | {0, 3, 6, 9} |

There currently exist certain challenges. For example, in support of UEs with different bandwidths, configuring separate PUCCH configurations and/or initial BWP for different UEs can result in resource fragmentation, thus degrading the spectral efficiency. Meanwhile, sharing the initial uplink BWP between different UEs with different bandwidth capabilities poses challenges because the initial BWP may be configured up to the entire carrier bandwidth. One issue that needs to be addressed is related to PUCCH transmissions for Msg4 (four-step RACH) or MsgB (two-step RACH) HARQ feedback during the random access procedure. Specifically, when frequency hopping is enabled for PUCCH in the initial uplink BWP, the physical resource blocks (PRBs) used for PUCCH are determined based on the initial uplink BWP configuration, which may have a bandwidth larger than the maximum UE bandwidth. In this case, it is important to enable/support that PUCCH (for Msg4/[MsgB] HARQ feedback) transmissions fall within the UE bandwidth. Therefore, proper support of PUCCH transmissions are needed to ensure efficient coexistence between UEs with different capabilities and avoid resource fragmentation. An example is illustrated in FIG. 2.

FIG. 2 is a frequency diagram illustrating an example of resource fragmentation due to different PUCCH configurations. The example illustrates the possibility of resource fragmentation when configuring different PUCCH resources for RedCap UEs and non-RedCap UEs (i.e., regular UEs). As shown in FIG. 2, with the different resources allocated to PUCCH for supporting non-RedCap and RedCap UEs, the remaining available resources for PUSCH are fragmented to 3 non-contiguous frequency-domain resources. This prevents the available PUSCH resources from being used for serving one UE if DFT-S-OFDM is used for PUSCH, because DFT-S-OFDM requires contiguous frequency-domain resource allocation. Thus, the available PUSCH resources may be unutilized if the gNB can only schedule one UE at the same time due to, e.g., that there is only one UE to be scheduled for PUSCH in the beam direction in a symbol or slot interval. Furthermore, in the current 3GPP specifications, the signaling solutions for efficient support of PUCCH transmissions for reduced bandwidth UEs do not exist.

### SUMMARY

As described above, certain challenges currently exist with physical uplink control channel (PUCCH) resources for reduced bandwidth wireless devices. Certain aspects of the present disclosure and their embodiments may provide solutions to these or other challenges. For example, particular embodiments support PUCCH transmissions of reduced bandwidth user equipment (UEs) to efficiently coexist with regular UEs in a network. Specifically, the solutions specify methods to ensure that PUCCH (for Msg4/[MsgB] HARQ feedback) transmissions for different UEs do not cause resource fragmentation. Particular embodiments determine suitable PUCCH resource sets that should be used by reduced bandwidth UEs in coexistence with legacy UEs. Moreover, particular embodiments identify effective rules for efficiently enabling and disabling PUCCH frequency hopping in various scenarios.

In general, certain embodiments (a) support PUCCH transmissions of reduced bandwidth UEs to efficiently coexist with regular UEs in a network; (b) include new PUCCH resource sets for PUCCH transmissions; (c) include signaling aspects for efficient PUCCH transmissions; (d) include effective rules for enabling and disabling PUCCH frequency hopping; and/or (e) prevent resource fragmentation when supporting UEs with different capabilities (e.g., bandwidths).

According to some embodiments, a method in a wireless device comprises determining a PUCCH resource set to be used by a RedCap wireless device for initial uplink and transmitting one or more PUCCH transmissions using the determined PUCCH resource set.

In particular embodiments, determining the PUCCH resource set comprises determining that frequency hopping is disabled. Determining that frequency hopping is disabled may be based on a presence of one or more non-RedCap wireless devices. Determining that frequency hopping is disabled may be based on one or more of on a number of RedCap wireless devices, number of non-RedCap wireless devices, a size of a bandwidth part (BWP) for initial uplink for a RedCap wireless device, a size of a BWP for initial uplink for a non-RedCap wireless device, and a size of carrier bandwidth. Determining that frequency hopping is disabled may be based on whether a non-RedCap wireless device supports transmission using non-contiguous frequency-domain resources. Determining that frequency hopping is disabled may be based on one or more of channel condition, number of antennas, bandwidth, and operating frequency.

In particular embodiments, determining the PUCCH resource set comprises selecting a PUCCH resource set associated with one hop of a frequency hopping configuration. Selecting the PUCCH resource set associated with one hop of the frequency hopping configuration may comprise selecting a PUCCH resource set closest to a carrier edge (e.g., top or bottom of the frequency spectrum). Selecting the PUCCH resource set associated with one hop of the frequency hopping configuration may be based on a center frequency of a carrier. Determining the PUCCH resource set may comprise determining one or more of a start symbol of PUCCH transmission, a physical resource block offset, and a cyclic shift index for a RedCap wireless device.

According to some embodiments, a wireless device comprises processing circuitry operable to perform any of the methods of the wireless device described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method in a network node comprises determining a PUCCH resource set to be used by a RedCap wireless device for initial uplink and transmitting an indication of the PUCCH resource set to the RedCap wireless device.

In particular embodiments, determining the PUCCH resource set comprises determining that frequency hopping is disabled. Determining that frequency hopping is disabled may be based on a presence of one or more non-RedCap wireless devices. Determining that frequency hopping is disabled may be based on one or more of on a number of RedCap wireless devices, number of non-RedCap wireless devices, a size of a BWP for initial uplink for a RedCap wireless device, a size of a BWP for initial uplink for a non-RedCap wireless device, and a size of carrier bandwidth. Determining that frequency hopping is disabled may be based on whether a non-RedCap wireless device supports transmission using non-contiguous frequency-domain resources. Determining that frequency hopping may be disabled is based on one or more of channel condition, number of antennas, bandwidth, and operating frequency.

In particular embodiments, determining the PUCCH resource set comprises selecting a PUCCH resource set associated with one hop of a frequency hopping configuration. Selecting the PUCCH resource set associated with one hop of the frequency hopping configuration may comprise selecting a PUCCH resource set closest to a carrier edge. Selecting the PUCCH resource set associated with one hop of the frequency hopping configuration may be based on a center frequency of a carrier. Determining the PUCCH resource set may comprise determining one or more of a start symbol of PUCCH transmission, a physical resource block offset, and a cyclic shift index for a RedCap wireless device.

According to some embodiments, a network node network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments support PUCCH transmissions of reduced bandwidth UEs to efficiently coexist with regular UEs in a network. The solutions may be beneficial for: 1) efficient support of UEs with different capabilities in a network, 2) capacity enhancements for control channels, and 3) resource utilization, avoiding resource fragmentation, scheduling flexibility, and network capacity.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a time and frequency diagram illustrating an example of physical uplink control channel (PUCCH) configuration with intra-slot frequency hopping enabled;

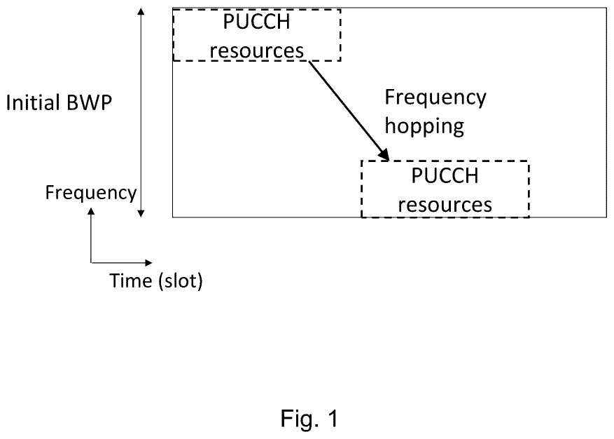

FIG. 2 is a frequency diagram illustrating an example of resource fragmentation due to different PUCCH configurations;

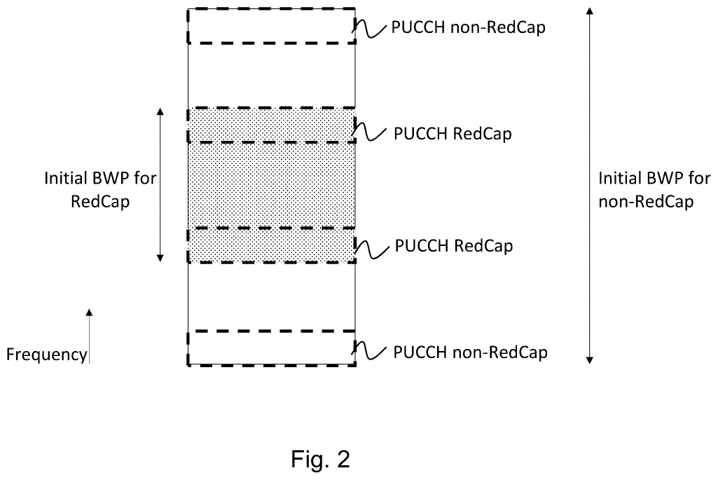

FIG. 3 is a frequency diagram illustrating an example of disabling the PUCCH frequency hopping for RedCap UEs based on the position of the bandwidth part (BWP);

FIG. 4 illustrates an example communication system, according to certain embodiments;

FIG. 5 illustrates an example user equipment (UE), according to certain embodiments;

FIG. 6 illustrates an example network node, according to certain embodiments;

FIG. 7 illustrates a block diagram of a host, according to certain embodiments;

FIG. 8 illustrates a virtualization environment in which functions implemented by some embodiments may be virtualized, according to certain embodiments;

FIG. 9 illustrates a host communicating via a network node with a UE over a partially wireless connection, according to certain embodiments;

FIG. 10 illustrates a method performed by a wireless device, according to certain embodiments; and

FIG. 11 illustrates a method performed by a network node, according to certain embodiments.

### DETAILED DESCRIPTION

As described above, certain challenges currently exist with physical uplink control channel (PUCCH) resources for reduced bandwidth wireless devices. Certain aspects of the present disclosure and their embodiments may provide solutions to these or other challenges. For example, particular embodiments support PUCCH transmissions of reduced bandwidth user equipment (UEs) to efficiently coexist with regular UEs in a network.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

As a non-limiting example of UEs with different bandwidths, particular examples consider RedCap UEs and non-RedCap UEs (regular New Radio (NR) UEs). As described above, PUCCH frequency hopping (FH) for RedCap UEs may cause physical uplink shared channel (PUSCH) resource fragmentation. One way to avoid the resource fragmentation is to properly disable PUCCH frequency hopping for RedCap UEs, when needed.

Accordingly, some embodiments include enabling and disabling PUCCH frequency hopping. In some embodiments, the PUCCH frequency hopping is dynamically enabled/disabled for a subset of RedCap UEs while it is semi-statically enabled/disabled via system information base (SIB) for other UEs.

In some embodiments, the PUCCH frequency hopping is enabled/disabled using both SIB and downlink control information (DCI). In this case, one indication may overwrite/change the other.

The following rules may be considered for enabling/disabling the PUCCH frequency hopping:
The FH is always disabled
The FH may be periodically enabled and disabled with a specific periodicity
The FH is enabled or disabled based on the presence of non-RedCap UEs
The FH is enabled or disabled based on the number of RedCap UEs, number of non-RedCap UEs, the sizes of BWPs for RedCap and non-RedCap, and size of the carrier bandwidth
The FH for RedCap UEs may be enabled/disabled based on the non-RedCap UE capability. For example, if non-RedCap UEs support transmission using non-contiguous frequency-domain resources, the PUCCH FH for RedCap may be enabled.
The FH is enabled/disabled based on the coverage condition. This depends on several factors including the channel condition, the number of antennas and bandwidth and operating frequency.

Some embodiments specify PUCCH resource sets that should be used for RedCap PUCCH transmissions. The frequency domain resource allocation for PUCCH before dedicated signaling with enabled PUCCH FH (i.e., two hops) is described in TS 38.213 (Section 9.2.1 PUCCH resource sets). Certain embodiments update this description for RedCap UEs with the option of disabled PUCCH FH where only one frequency hop can be used.

In addition, certain embodiments specify which hop is used for PUCCH transmissions when the FH is disabled. In general, it is desired to have the PUCCH transmissions at the carrier edge to prevent the PUSCH resource fragmentation. Therefore, it is desired to use the PUCCH hop located at the carrier edge and disable the one which is in the middle of the carrier.

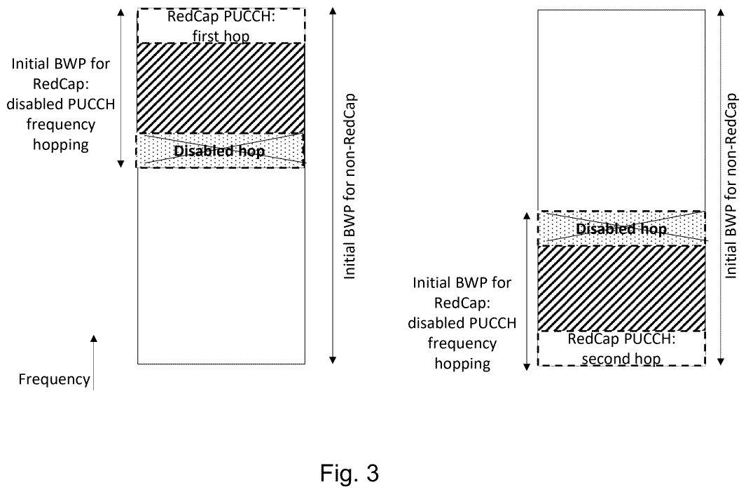

In some embodiments, the PUCCH resource hop located at the carrier edge is enabled and the one that is in the middle of the carrier is disabled. This is done based on the position of the RedCap uplink BWP. An example is illustrated in FIG. 3.

FIG. 3 is a frequency diagram illustrating an example of disabling the PUCCH FH for RedCap UEs based on the position of the BWP.

Specifically, considering the existing PUCCH resource sets in the specifications (TS 38.213, Section 9.2.1 PUCCH resource sets), the PRB index for RedCap PUCCH transmissions can be determined based on the following rules:

If └r_{PUCCH}/8┘=0:

If the RedCap UL BWP is located at the lower edge of the carrier: the UE determines the PRB index of the PUCCH transmission as

$${RB}_{BWP}^{offset} + ⌊ {r}_{PUCCH} / {N}_{CS} ⌋$$

which is located at the lower edge of the RedCap UL BWP.

If the RedCap UL BWP is located at the higher edge of the carrier: the UE determines the PRB index of the PUCCH transmission as

$${N}_{BWP}^{size} - 1 - {RB}_{BWP}^{offset} - ⌊ {r}_{PUCCH} / {N}_{CS} ⌋ ,$$

which is located at the higher edge of the RedCap UL BWP.

If └r_{PUCCH}/8┘=1:

If the RedCap UL BWP is located at the lower edge of the carrier: the UE determines the PRB index of the PUCCH transmission as

$${RB}_{BWP}^{offset} + ⌊ ( {r}_{PUCCH} - 8 ) / {N}_{CS} ⌋ ,$$

which is located at the lower edge of the RedCap UL BWP.

If the RedCap UL BWP is located at the higher edge of the carrier: the UE determines the PRB index of the PUCCH transmission as

$${N}_{BWP}^{size} - 1 - {RB}_{BWP}^{offset} - ⌊ ( {r}_{PUCCH} - 8 ) / {N}_{CS} ⌋ ,$$

which is located at the higher edge of the RedCap UL BWP.

Here,

$${N}_{BWP}^{size}$$

the size of RedCap UL BWP, N_{CS} is the total number of initial cyclic shift indexes in the set of initial cyclic shift indexes. The UE determines the initial cyclic shift index in the set of initial cyclic shift indexes as (r_{PUCCH}−8)mod N_{CS}.

In some embodiments, the PRB index for PUCCH transmission may be determined as follows:
Condition 1: the UE determines the PRB index of the PUCCH transmission as

$${RB}_{BWP}^{offset} + ⌊ {r}_{PUCCH} / {N}_{CS} ⌋ ,$$

which is located at the lower edge of the RedCap UL BWP.
Condition 2: the UE determines the PRB index of the PUCCH transmission as

$${N}_{BWP}^{size} - 1 - {RB}_{BWP}^{offset} - ⌊ {r}_{PUCCH} / {N}_{CS} ⌋ ,$$

which is located at the higher edge of the RedCap UL BWP.
Condition 3: the UE determines the PRB index of the PUCCH transmission as

$${RB}_{BWP}^{offset} + ⌊ ( {r}_{PUCCH} - 8 ) / {N}_{CS} ⌋ ,$$

which is located at the lower edge of the RedCap UL BWP.
Condition 4: the UE determines the PRB index of the PUCCH transmission as

$${N}_{BWP}^{size} - 1 - {RB}_{BWP}^{offset} - ⌊ ( {r}_{PUCCH} - 8 ) / {N}_{CS} ⌋ ,$$

which is located at the higher edge of the RedCap UL BWP.

Which of the conditions (condition 1 and/or condition 2 and/or condition 3 and/or condition 4) to use to determine the PRB index for PUCCH transmissions may be based on an indication in SIB1. Alternatively, one or more of the conditions (from conditions 1, 2, 3 and 4) may be predefined in the specification. As another alternative, which condition to use may be determined based on the center frequency of the initial UL BWP for RedCap and the center frequency of the carrier. For example, if the center frequency of the initial UL BWP is lower that of center frequency of the carrier, conditions 1 and/or 3 may be used. Otherwise, conditions 2 and/or 4 may be used.

Note that the above are examples of different approaches for determining the PUCCH resources. It should also be noted that the UE is not limited to use only PRBs located near the carrier edge. In principle, the UE may use PRBs located in the middle of the carrier (i.e., a hop not located at the carrier edge). This can be based on several factors including: presence of non-RedCap UEs, PUCCH resources used for non-RedCap, number of RedCap and non-RedCap UEs, and size of the BWPs. Moreover, the rules described above for enabling/disabling PUCCH FH may be applied for determining the frequency hop used for RedCap PUCCH transmissions.

In some embodiments, the rule for determining the hop used for RedCap PUCCH for disabled FH is based on the center frequency of the BWPs for RedCap and non-RedCap UEs. For example, if the center frequency of the RedCap BWP is below the non-RedCap BWP, then PRBs at the lower edge are used for RedCap PUCCH. Otherwise, PRBs located at the higher edge are used for RedCap PUCCH.

In some embodiments, the table corresponding the PUCCH resource sets for legacy UEs (TS 38.213, Section 9.2.1 PUCCH resource sets) is updated for RedCap UEs to efficiently support multiplexing of RedCap UEs and non-RedCap UE and enhancing the PUCCH capacity. In particular, new values are introduced for RedCap UEs at least for the following parameters:
First symbol: the start symbol of PUCCH transmission may be different for RedCap UEs and non-RedCap UEs to avoid overlapping PUCCH resources. The start symbol may depend on the PUCCH duration and PUCCH format.
PRB offset: new PRB offset values may be used for RedCap UEs to facilitate using more PRBs for PUCCH transmissions
Set of initial CS (cyclic shift) indexes: new CS indexes may be used for RedCap UEs to improve multiplexing capacity

The procedure of determining the hop used for RedCap PUCCH for disabled FH may also be based on the new parameters described above.

Certain embodiments of the present disclosure may be implemented within the context of a standard, such as TS 38.213, TS 38.211, TS 38.331, Rel-17, Rel-18 and beyond.

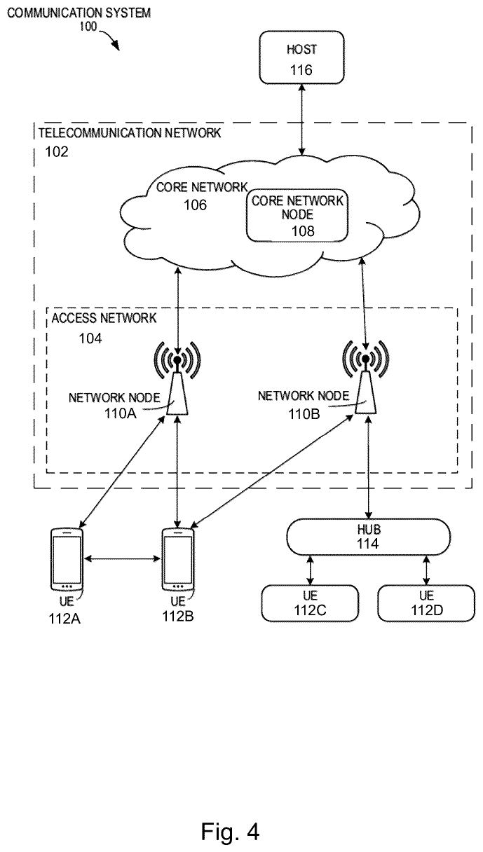

FIG. 4 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of 1 FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

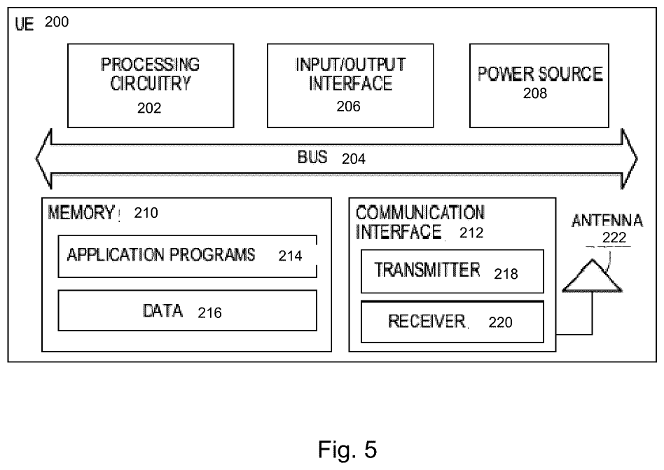

FIG. 5 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

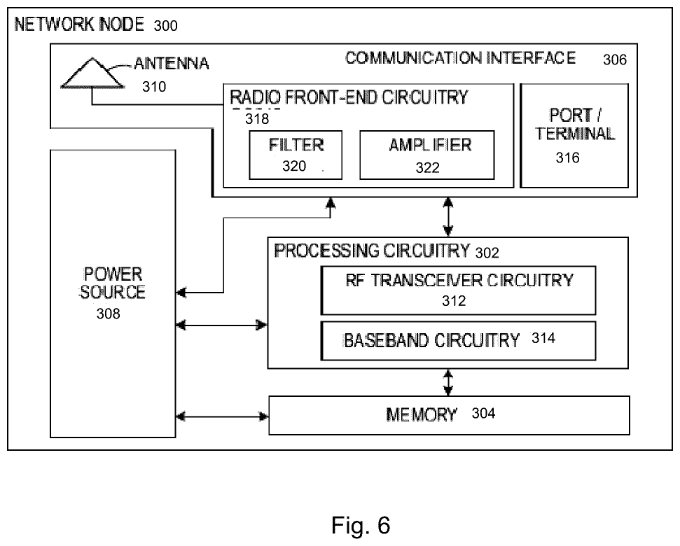

FIG. 6 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 6 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

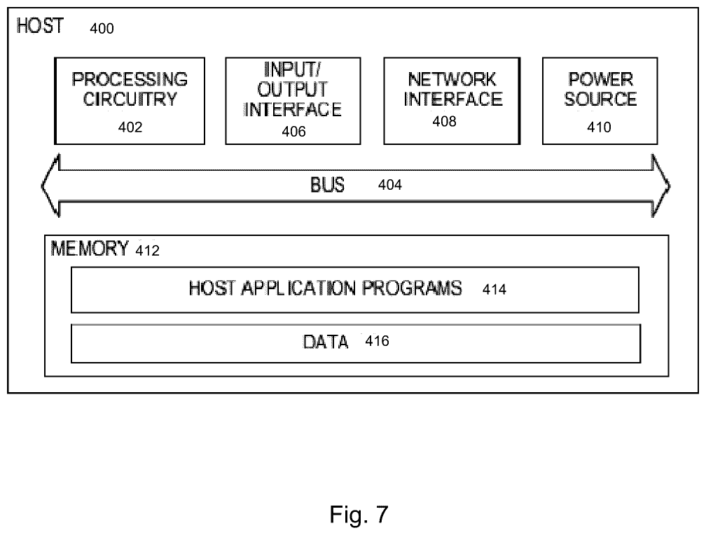

FIG. 7 is a block diagram of a host 400, which may be an embodiment of the host 116 of 1 FIG. 4, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 3 and 4, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

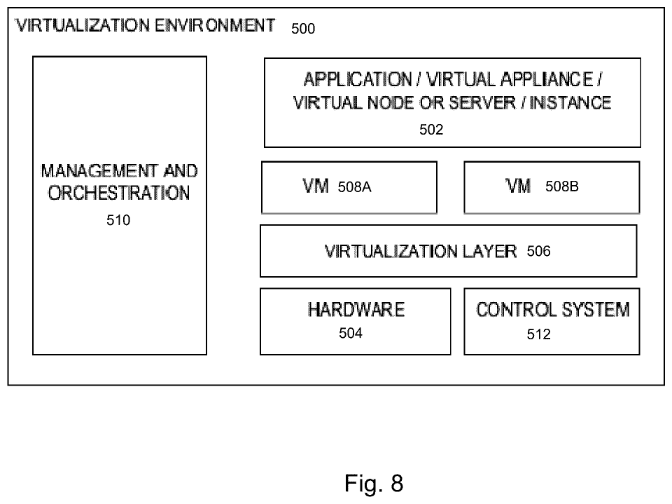

FIG. 8 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

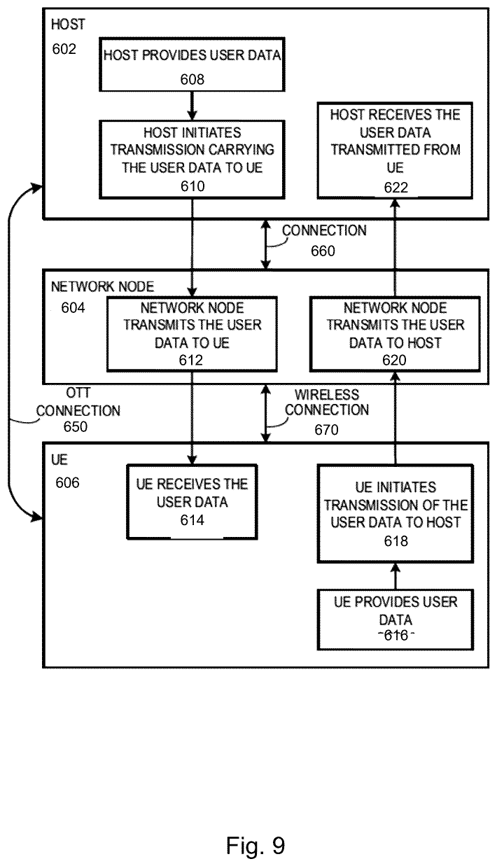

FIG. 9 shows a communication diagram of a host 602 communicating via a network node 604 with a UE 606 over a partially wireless connection in accordance with some embodiments. Example implementations, in accordance with various embodiments, of the UE (such as a UE 112a of FIG. 4 and/or UE 200 of FIG. 5), network node (such as network node 110a of FIG. 4 and/or network node 300 of FIG. 6), and host (such as host 116 of FIG. 4 and/or host 400 of FIG. 7) discussed in the preceding paragraphs will now be described with reference to FIG. 9.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 4) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the delay to directly activate an SCell by RRC and power consumption of user equipment and thereby provide benefits such as reduced user waiting time and extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

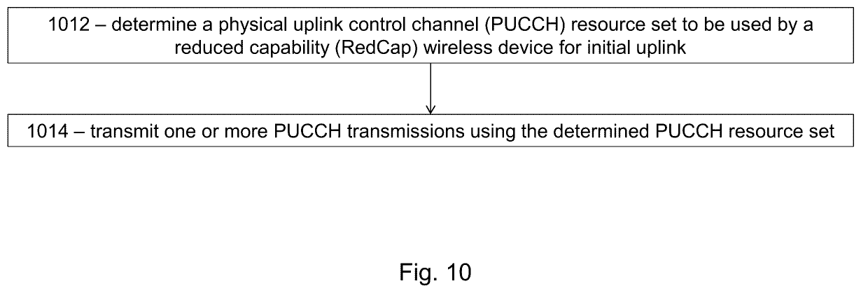

FIG. 10 is a flowchart illustrating an example method in a wireless device, according to certain embodiments. In particular embodiments, one or more steps of FIG. 10 may be performed by UE 200 described with respect to FIG. 5.

The method begins at step 1012, where the wireless device (e.g., UE 200) determines a PUCCH resource set to be used by a RedCap wireless device for initial uplink.

In particular embodiments, determining the PUCCH resource set comprises determining that frequency hopping is disabled. Determining that frequency hopping is disabled may be based on a presence of one or more non-RedCap wireless devices. Determining that frequency hopping is disabled may be based on one or more of on a number of RedCap wireless devices, number of non-RedCap wireless devices, a size of a bandwidth part (BWP) for initial uplink for a RedCap wireless device, a size of a BWP for initial uplink for a non-RedCap wireless device, and a size of carrier bandwidth. Determining that frequency hopping is disabled may be based on whether a non-RedCap wireless device supports transmission using non-contiguous frequency-domain resources. Determining that frequency hopping is disabled may be based on one or more of channel condition, number of antennas, bandwidth, and operating frequency.

In particular embodiments, determining the PUCCH resource set comprises selecting a PUCCH resource set associated with one hop of a frequency hopping configuration. Selecting the PUCCH resource set associated with one hop of the frequency hopping configuration may comprise selecting a PUCCH resource set closest to a carrier edge. Selecting the PUCCH resource set associated with one hop of the frequency hopping configuration may be based on a center frequency of a carrier. Determining the PUCCH resource set may comprise determining one or more of a start symbol of PUCCH transmission, a physical resource block offset, and a cyclic shift index for a RedCap wireless device.

In particular embodiments, determining the PUCCH resource set comprises receiving a PUCCH resource set configuration from a wireless device (e.g., via broadcast or direct signaling), determining the PUCCH resource set based on a standard, and/or autonomously determining the PUCCH resource set. In particular embodiments, the wireless device determines the PUCCH resource set according to any of the embodiments and examples described herein.

At step 1014, the wireless device transmits one or more PUCCH transmissions using the determined PUCCH resource set. For example, the wireless device may perform initial uplink using the PUCCH resource set.

Modifications, additions, or omissions may be made to method 1000 of FIG. 10. Additionally, one or more steps in the method of FIG. 10 may be performed in parallel or in any suitable order.

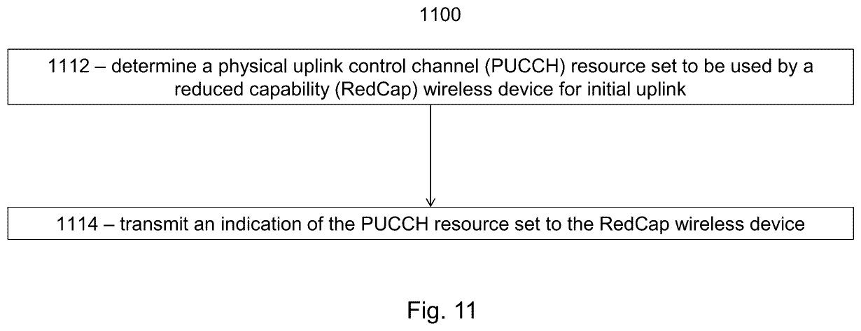

FIG. 11 is a flowchart illustrating an example method in a network node, according to certain embodiments. In particular embodiments, one or more steps of FIG. 11 may be performed by network node 300 described with respect to FIG. 6.

The method begins at step 1112, where the network node (e.g., network node 300) determines a PUCCH resource set to be used by a RedCap wireless device for initial uplink.

In particular embodiments, determining the PUCCH resource set comprises determining that frequency hopping is disabled. Determining that frequency hopping is disabled may be based on a presence of one or more non-RedCap wireless devices. Determining that frequency hopping is disabled may be based on one or more of on a number of RedCap wireless devices, number of non-RedCap wireless devices, a size of a BWP for initial uplink for a RedCap wireless device, a size of a BWP for initial uplink for a non-RedCap wireless device, and a size of carrier bandwidth. Determining that frequency hopping is disabled may be based on whether a non-RedCap wireless device supports transmission using non-contiguous frequency-domain resources. Determining that frequency hopping may be disabled is based on one or more of channel condition, number of antennas, bandwidth, and operating frequency.

In particular embodiments, determining the PUCCH resource set comprises selecting a PUCCH resource set associated with one hop of a frequency hopping configuration. Selecting the PUCCH resource set associated with one hop of the frequency hopping configuration may comprise selecting a PUCCH resource set closest to a carrier edge. Selecting the PUCCH resource set associated with one hop of the frequency hopping configuration may be based on a center frequency of a carrier. Determining the PUCCH resource set may comprise determining one or more of a start symbol of PUCCH transmission, a physical resource block offset, and a cyclic shift index for a RedCap wireless device.

In particular embodiments, the network node determines the PUCCH resource set according to any of the embodiments and examples described herein.

At step 1114, the network node transmits an indication of the PUCCH resource set to the RedCap wireless device (e.g., wireless device 110). The wireless device may use the PUCCH resource set for initial uplink.

Modifications, additions, or omissions may be made to method 1100 of FIG. 11. Additionally, one or more steps in the method of FIG. 11 may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a wireless device, the method comprising:
determining a physical uplink control channel (PUCCH) resource set to be used by a reduced capability (RedCap) wireless device for initial uplink; and
transmitting one or more PUCCH transmissions using the determined PUCCH resource set.

2.-10. (canceled)

11. A wireless device comprising processing circuitry operable to:
determine a physical uplink control channel (PUCCH) resource set to be used by a reduced capability (RedCap) wireless device for initial uplink; and
transmit one or more PUCCH transmissions using the determined PUCCH resource set.

12. The wireless device of claim 11, wherein the processing circuitry is operable to determine the PUCCH resource set by determining that frequency hopping is disabled.

13. The wireless device of claim 12, wherein the processing circuitry is operable to determine that frequency hopping is disabled based on a presence of one or more non-RedCap wireless devices.

14. The wireless device of claim 12, wherein the processing circuitry is operable to determine that frequency hopping is disabled based on one or more of on a number of RedCap wireless devices, number of non-RedCap wireless devices, a size of a bandwidth part (BWP) for initial uplink for a RedCap wireless device, a size of a BWP for initial uplink for a non-RedCap wireless device, and a size of carrier bandwidth.

15. The wireless device of claim 12, wherein the processing circuitry is operable to determine that frequency hopping is disabled based on whether a non-RedCap wireless device supports transmission using non-contiguous frequency-domain resources.

16. The wireless device of claim 12, wherein the processing circuitry is operable to determine that frequency hopping is disabled based on one or more of channel condition, number of antennas, bandwidth, and operating frequency.

17. The wireless device of claim 11, wherein the processing circuitry is operable to determine the PUCCH resource set by selecting a PUCCH resource set associated with one hop of a frequency hopping configuration.

18. The wireless device of claim 17, wherein the processing circuitry is operable to select the PUCCH resource set associated with one hop of the frequency hopping configuration comprises selecting a PUCCH resource set closest to a carrier edge.

19. The wireless device of claim 17, wherein the processing circuitry is operable to select the PUCCH resource set associated with one hop of the frequency hopping configuration based on a center frequency of a carrier.

20. The wireless device of claim 11, wherein the processing circuitry is operable to determine the PUCCH resource set by determining one or more of a start symbol of PUCCH transmission, a physical resource block offset, and a cyclic shift index for a RedCap wireless device.

21. A method performed by a network, the method comprising:
determining a physical uplink control channel (PUCCH) resource set to be used by a reduced capability (RedCap) wireless device for initial uplink; and
transmitting an indication of the PUCCH resource set to the RedCap wireless device.

22.-30. (canceled)

31. A network node comprising processing circuitry operable to:
determine) a physical uplink control channel (PUCCH) resource set to be used by a reduced capability (RedCap) wireless device for initial uplink; and
transmit an indication of the PUCCH resource set to the RedCap wireless device.

32. The network node of claim 31, wherein the processing circuitry is operable to determine the PUCCH resource set by determining that frequency hopping is disabled.

33. The network node of claim 32, wherein the processing circuitry is operable to determine that frequency hopping is disabled based on a presence of one or more non-RedCap wireless devices.

34. The network node of claim 32, wherein the processing circuitry is operable to determine that frequency hopping is disabled based on one or more of on a number of RedCap wireless devices, number of non-RedCap wireless devices, a size of a bandwidth part (BWP) for initial uplink for a RedCap wireless device, a size of a BWP for initial uplink for a non-RedCap wireless device, and a size of carrier bandwidth.

35. The network node of claim 32, wherein the processing circuitry is operable to determine that frequency hopping is disabled based on whether a non-RedCap wireless device supports transmission using non-contiguous frequency-domain resources.

36. The network node of claim 32, wherein the processing circuitry is operable to determine that frequency hopping is disabled based on one or more of channel condition, number of antennas, bandwidth, and operating frequency.

37. The network node of claim 31, wherein the processing circuitry is operable to determine the PUCCH resource set by selecting a PUCCH resource set associated with one hop of a frequency hopping configuration.

38. The network node of claim 37, wherein the processing circuitry is operable to select the PUCCH resource set associated with one hop of the frequency hopping configuration by selecting a PUCCH resource set closest to a carrier edge.

39. The network node of claim 37, wherein the processing circuitry is operable to select the PUCCH resource set associated with one hop of the frequency hopping configuration based on a center frequency of a carrier.

40. The network node of claim 31, wherein the processing circuitry is operable to determine the PUCCH resource set by determining one or more of a start symbol of PUCCH transmission, a physical resource block offset, and a cyclic shift index for a RedCap wireless device.
